(19) United States
(12) Patent Application Publication
(10) Pub. No.: US 2020/0413029 A1
(43) Pub. Date: Dec. 31, 2020

(54) SYSTEM FOR PROJECTING NAKED-EYE 3D IMAGE FROM SELECTED 2D IMAGE

(71) Applicant: National Taiwan Normal University, Taipei City (TW)

(72) Inventors: Chun-Yen CHANG, Taipei City (TW); Wei-Kai LIOU, Taipei City (TW)

(21) Appl. No.: 16/909,133

(22) Filed: Jun. 23, 2020

(30) Foreign Application Priority Data
Jun. 25, 2019 (TW) 108122185

(51) Int. Cl. H04N 13/302; H04N 13/363; H04N 9/31

(52) U.S. Cl. CPC H04N 13/302; H04N 9/3141; H04N 9/3188; H04N 13/363

(57) ABSTRACT

A system, for projecting a naked-eye three-dimensional image from a selected two-dimensional image, includes a data processing apparatus, a projection screen device and an image projection apparatus. The selected two-dimensional image is imported into the data processing apparatus. A predetermined three-dimensional virtual sphere is stored in the data processing apparatus. At least one processor of the data processing apparatus executes an image processing application to project the selected two-dimensional image onto the predetermined three-dimensional virtual sphere according to a spherical plane coordinate conversion method to generate a three-dimensional spherical volume image. The image projection apparatus is capable of communicating with the data processing apparatus. The data processing apparatus projects the three-dimensional spherical volume image onto the hemispherical projection surface via the image projection apparatus such that the naked-eye three-dimensional image associated with the three-dimensional spherical volume image is exhibited on a hemispherical projection surface of the projection screen device.

### CROSS-REFERENCE TO RELATED APPLICATION

This utility application claims priority to Taiwan Application Serial Number 108122185, filed Jun. 25, 2019, which is incorporated herein by reference.

### BACKGROUND OF THE INVENTION

### 1. Field of the Invention

This present invention relates to a system for exhibiting a naked-eye three-dimensional image, and more particularly, to a system for projecting a three-dimensional spherical volume image from a selected two-dimensional image to exhibit a naked-eye three-dimensional image.

### 2. Description of the Prior Art

In schools, planetariums, museums, and other institutions, various sizes of solid earth, planetary instruments, and other sphere models are commonly used in teaching or display. In recent years, as technologies progress, some researchers have attempted to project images, generated by earth simulation software or other star simulation software, onto screens as digital teaching auxiliary aids.

In addition, in terms of advertising and photography, the three-dimensional images projected on the sphere also have special visual effects.

Current display system simulating earth or star globes by three-dimensional image projection technology will be described as follows. One prior art, such as disclosed in U.S. Patent Pub. No. 2006/0256302, utilizes multiple projectors disposed at different positions to synchronously project respective images in different orientations on a sphere. Each image projected by the corresponding projector represents an image of a specific region on the sphere, and all images on the sphere are pieced together into a complete surface projection spliced image.

Another prior art uses a three-dimensional internal back projection way. The prior art projects coherent light rays from a coherent light source onto an inner surface of a three-dimensional projection surface. A compact image can thereby be formed and seen by a viewer from outside the properly constructed three-dimensional projection surface. The prior art can be practiced to show examples of things that can be represented on such a surface are celestial bodies and planets like the Earth or other stars. The prior art is described in details in U.S. Pat. No. 8,066,378.

Another prior art relates to a three-dimensional convex surface display system which has a display surface of a three-dimensional convex shape. The projection system in the display system projects a medium image to an object field through lens system onto a continuous image field located on the interior of the display surface to provide the image simulating star globes. The prior art is described in details in U.S. Pat. No. 7,352,340.

Another prior art relates to three-dimensional internal projection system which projects an image in optical scanning or projection methods onto an inner surface of a large three-dimensional object such that viewers from outside watch the image with stereoscopic imaging effect. The prior art is described in details in U.S. Patent Pub. No. 2009/0027622.

Obviously, due to complicated architecture and high cost, current display systems of the prior arts simulating earth or star globes are unfavorable to employing simple equipment to implement.

In addition, the three-dimensional global volume images to be projected by the display systems of the prior arts simulating earth or star globes must be created previously. Obviously, the prior arts greatly limit the richness, real-time and time continuity of the three-dimensional images finally exhibited. As far as the dimensions of current images are concerned, it is well known that the vast majority are two-dimensional images. If simple information equipment and instruments can be used to quickly project the two-dimensional image into a naked-eye three-dimensional image, it can solve the problems of complicated structure, high cost and insufficient source of images in the prior arts.

If it is supplemented by storing a large number of two-dimensional images in the cloud storage system, selecting the two-dimensional images from the large number of two-dimensional images stored in the cloud storage system, and being projected into a naked-eye three-dimensional image eventually, it can solve the problem that the prior arts cannot exhibit the three-dimensional image in real time. Regarding images with time continuity, for example, actual path maps of typhoons are mostly presented as two-dimensional images at different time points. At present, no display systems of the prior arts can exhibit a three-dimensional image of the actual path map of the typhoon.

### SUMMARY OF THE INVENTION

Accordingly, a scope of the invention is to provide a system for exhibiting a naked-eye three-dimensional image. In particular, the system according to the invention can project a three-dimensional spherical volume image from a selected two-dimensional image to exhibit a naked-eye three-dimensional image. The system according to the invention can solve the problems of the display systems of the prior arts and provide functions that the display systems of the prior arts do not have.

A system, according to a preferred embodiment of the invention, for projecting a naked-eye three-dimensional image from a selected two-dimensional image includes a data processing apparatus, a projection screen device and an image projection apparatus. The data processing apparatus includes at least one processor. The selected two-dimensional image is imported into the data processing apparatus. A predetermined three-dimensional virtual sphere is stored in the data processing apparatus. The at least one processor of the data processing apparatus executes an image processing application to project the selected two-dimensional image onto the predetermined three-dimensional virtual sphere according to a spherical plane coordinate conversion method to generate a three-dimensional spherical volume image. The projection screen device has a hemispherical projection surface. The image projection apparatus is capable of communicating with the data processing apparatus. The data processing apparatus projects the three-dimensional spherical volume image onto the hemispherical projection surface via the image projection apparatus such that the naked-eye three-dimensional image associated with the three-dimensional spherical volume image is exhibited on the hemispherical projection surface.

In one embodiment, the spherical plane coordinate conversion method can be a longitude and latitude mapping method, a spherical coordinate positioning method, a Mercator projection method, a Gauss projection method or other spherical plane coordinate conversion method.

Further, the system according to the preferred embodiment of the invention also includes a distance sensing apparatus. The distance sensing apparatus is capable of communicating with the data processing apparatus. The distance sensing apparatus is disposed to sense a distance between the image projection apparatus and the projection screen device, and to transmit the sensed distance to the data processing apparatus. The at least one processor of the data processing apparatus executes the image processing application to adjust a size of the three-dimensional spherical volume image in accordance with the sensed distance such that the naked-eye three-dimensional image is completely fitted on the hemispherical projection surface.

Further, the system according to the preferred embodiment of the invention also includes an image capturing apparatus. The image capturing apparatus is capable of communicating with the data processing apparatus. The image capturing apparatus is disposed to capture a captured image associated with the naked-eye three-dimensional image, and to transmit the captured image to the data processing apparatus. The at least one processor of the data processing apparatus executes the image processing application to adjust a size of the three-dimensional spherical volume image in accordance with the captured image such that the naked-eye three-dimensional image is completely fitted on the hemispherical projection surface.

In one embodiment, the data processing apparatus links to a cloud storage system through a network. A plurality of candidate two-dimensional images are stored in the cloud storage system. A user operates the data processing apparatus to link to the cloud storage system through the network, to select the selected two-dimensional image from the plurality of candidate two-dimensional images, and to import the selected two-dimensional image into the data processing apparatus.

In one embodiment, the data processing apparatus links to a cloud storage system through a network. A plurality of candidate two-dimensional images are stored in the cloud storage system. A user operates the data processing apparatus to link to the cloud storage system through the network, to select a plurality of images to be processed from the plurality of candidate two-dimensional images, and to import the plurality of images to be processed into the data processing apparatus. The at least one processor executes the image processing application to splice the plurality of images to be processed into the selected two-dimensional image.

Distinguishable from the prior arts, the system according to the invention can utilize simple information equipment and instruments to quickly project a selected two-dimensional image into a naked-eye three-dimensional image. The system according to the invention can solve the problems of complicated structure, high cost and insufficient source of images in the prior arts. The system according to the invention can also solve the problem that the prior arts cannot exhibit the three-dimensional image in real time.

The advantage and spirit of the invention may be understood by the following recitations together with the appended drawings.

### BRIEF DESCRIPTION OF THE APPENDED DRAWINGS

FIG. 1 is a schematic diagram showing the architecture of the system according to the preferred embodiment of the invention for projecting a naked-eye three-dimensional image from a selected two-dimensional image.

FIG. 2 is another schematic diagram showing the architecture of the system according to the preferred embodiment of the invention.

FIG. 3 is a functional block diagram of the data processing apparatus of the system according to the preferred embodiment of the invention.

FIG. 4 is a frame diagram of an image processing application executed by the system according to the preferred embodiment of the invention.

FIG. 5 is a schematic diagram showing the architecture of the system according to the preferred embodiment of the invention and the linked cloud storage system.

FIG. 6 is another schematic diagram showing the architecture of the system according to the preferred embodiment of the invention and the linked cloud storage system.

### DETAILED DESCRIPTION OF THE INVENTION

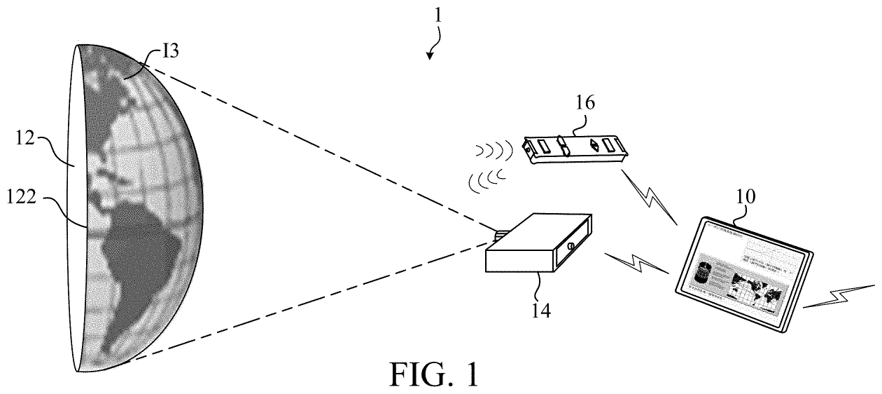

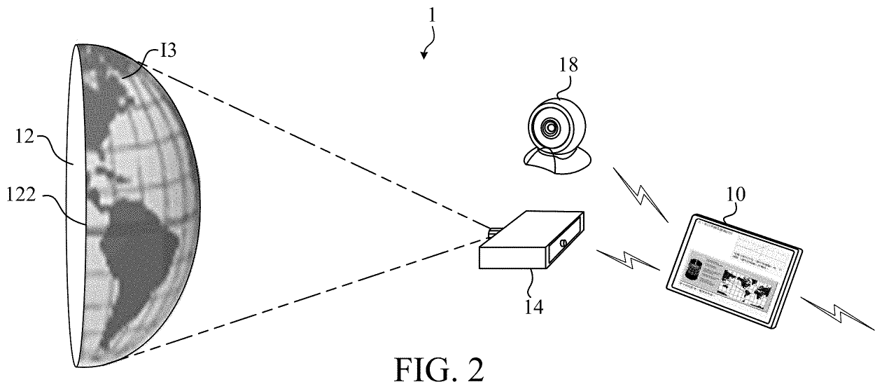

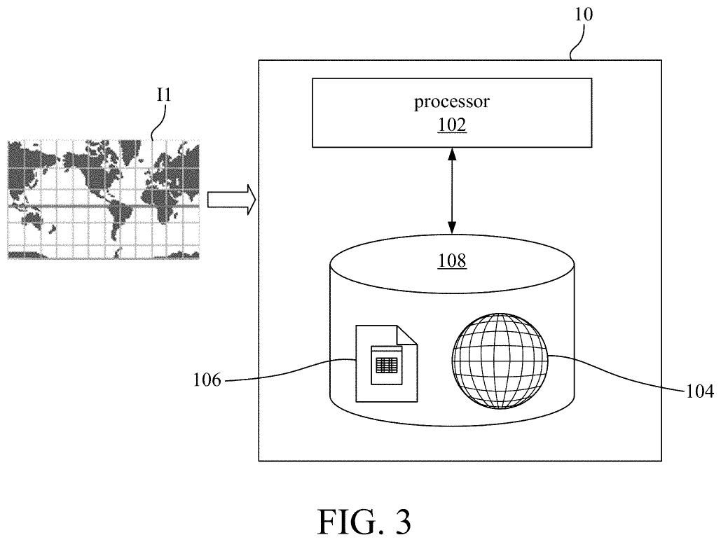

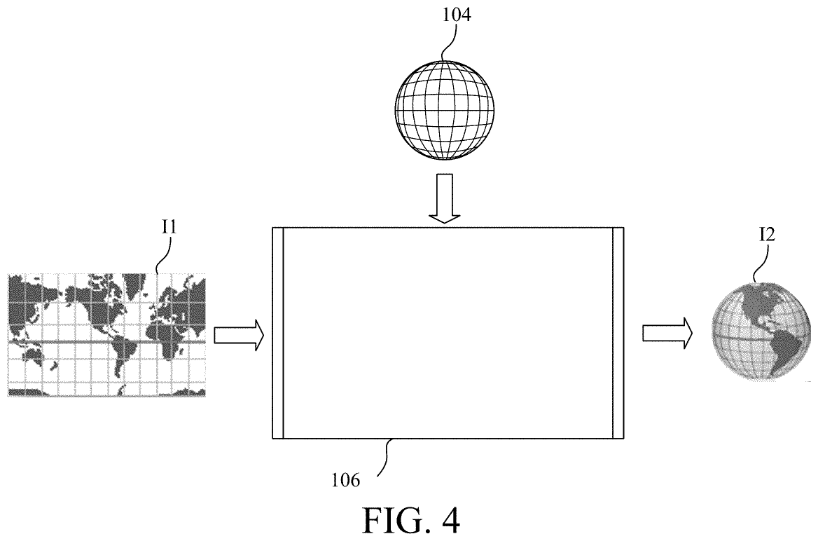

Referring to FIG. 1 to FIG. 4, FIG. 1 is a schematic diagram showing the architecture of the system 1 according to the preferred embodiment of the invention for projecting a naked-eye three-dimensional image 13 from a selected two-dimensional image I1. FIG. 2 is another schematic diagram showing the architecture of the system 1 according to the preferred embodiment of the invention. FIG. 3 is a functional block diagram of the data processing apparatus 10 of the system 1 according to the preferred embodiment of the invention. FIG. 4 is a frame diagram of an image processing application executed by the system 1 according to the preferred embodiment of the invention.

As shown in FIG. 1, FIG. 2 and FIG. 3, the system 1 according to the preferred embodiment of the invention includes a data processing apparatus 10, a projection screen device 12 and an image projection apparatus 14.

As shown in FIG. 3, the data processing apparatus 10 includes at least one processor 102. In FIG. 3, only one processor 102 is illustrated as a representative. The selected two-dimensional image I1 is imported into the data processing apparatus 10. A predetermined three-dimensional virtual sphere 104 is stored in the data processing apparatus 10. As shown in FIG. 4, the at least one processor 102 of the data processing apparatus 10 executes an image processing application 106 to project the selected two-dimensional image I1 onto the predetermined three-dimensional virtual sphere 104 according to a spherical plane coordinate conversion method to generate a three-dimensional spherical volume image 12. Also as shown in FIG. 3, the data processing apparatus 10 also includes a data storage unit 108 in which the predetermined three-dimensional virtual sphere 104 and the image processing application 106 can be stored.

In practical application, the data processing apparatus 10 can be a desktop computer, a notebook computer, a tablet computer, a personal digital assistant, a smart phone, or other apparatus with data computing capabilities.

In one embodiment, the spherical plane coordinate conversion method can be a longitude and latitude mapping method, a spherical coordinate positioning method, a Mercator projection method, a Gauss projection method or other spherical plane coordinate conversion method.

The projection screen device 12 has a hemispherical projection surface 122. The image projection apparatus 14 is capable of communicating with the data processing apparatus 10.

In one embodiment, the image projection apparatus 14 complies with a first wireless communication protocol to communicate with the data processing apparatus 10. The first wireless communication protocol can be an Intel WiDi protocol, a WiFi Display protocol, a WHDI protocol, a WiDi protocol, a 5G WiFi protocol, a WiGig 802.11ad protocol, a WiHD 802.11ac protocol, IEEE 802.11 protocols, a 3G network protocol, a 4G network protocol, a 5G network protocol, a 6G network protocol, an HSPA network protocol, an LTE network protocol, a bluetooth protocol, or other commercial wireless communication protocol.

The data processing apparatus 10 projects the three-dimensional spherical volume image 12 onto the hemispherical projection surface 122 via the image projection apparatus 14 such that the naked-eye three-dimensional image 13 associated with the three-dimensional spherical volume image 12 is exhibited on the hemispherical projection surface 122. A user operates the data processing apparatus 10 to execute the image processing application 106 to rotate the three-dimensional spherical volume image 12, and the naked-eye three-dimensional image 13 projected on the hemispherical projection surface 122 of the projection screen device 12 will rotate accordingly.

In practical application, the projection screen device 12 can be a solid spheroid, a solid hemispheroid, a whole spherical shell, a hemispheric shell, and so on to provide the hemispherical projection surface 122.

Further, also as shown in FIG. 1, the system 1 according to the preferred embodiment of the invention also includes a distance sensing apparatus 16. The distance sensing apparatus 16 is capable of communicating with the data processing apparatus 10. In one embodiment, the distance sensing apparatus 16 complies with a second wireless communication protocol to communicate with the data processing apparatus 10. The second wireless communication protocol can be an Intel WiDi protocol, a WiFi Display protocol, a WHDI protocol, a WiDi protocol, a 5G WiFi protocol, a WiGig 802.11ad protocol, a WiHD 802.11ac protocol, IEEE 802.11 protocols, a 3G network protocol, a 4G network protocol, a 5G network protocol, a 6G network protocol, an HSPA network protocol, an LTE network protocol, a bluetooth protocol, or other commercial wireless communication protocol.

The distance sensing apparatus 16 is disposed to sense a distance between the image projection apparatus 14 and the projection screen device 12, and to transmit the sensed distance to the data processing apparatus 10. The at least one processor 102 of the data processing apparatus 10 executes the image processing application 106 to adjust a size of the three-dimensional spherical volume image 12 in accordance with the sensed distance such that the naked-eye three-dimensional image 13 is completely fitted on the hemispherical projection surface 122.

In one embodiment, the distance sensing apparatus 16 emits an optical wave (for example, a laser beam) or an acoustic wave to sense the distance between the image projection apparatus 14 and the projection screen device 12.

Further, also as shown in FIG. 2, the system 1 according to the preferred embodiment of the invention also includes an image capturing apparatus 18. The image capturing apparatus 18 is capable of communicating with the data processing apparatus 10. In one embodiment, the image capturing apparatus 18 complies with a third wireless communication protocol to communicate with the data processing apparatus 10. The third wireless communication protocol can be an Intel WiDi protocol, a WiFi Display protocol, a WHDI protocol, a WiDi protocol, a 5G WiFi protocol, a WiGig 802.11ad protocol, a WiHD 802.11ac protocol, IEEE 802.11 protocols, a 3G network protocol, a 4G network protocol, a 5G network protocol, a 6G network protocol, an HSPA network protocol, an LTE network protocol, a bluetooth protocol, or other commercial wireless communication protocol.

The image capturing apparatus 18 is disposed to capture a captured image associated with the naked-eye three-dimensional image 13, and to transmit the captured image to the data processing apparatus 10. The at least one processor 102 of the data processing apparatus 10 executes the image processing application 106 to adjust a size of the three-dimensional spherical volume image 12 in accordance with the captured image such that the naked-eye three-dimensional image 13 is completely fitted on the hemispherical projection surface 122.

Obviously, the system 1 according to the invention can be implemented using simple information equipment and instruments, and can even be easily transported to any site and be easily set up.

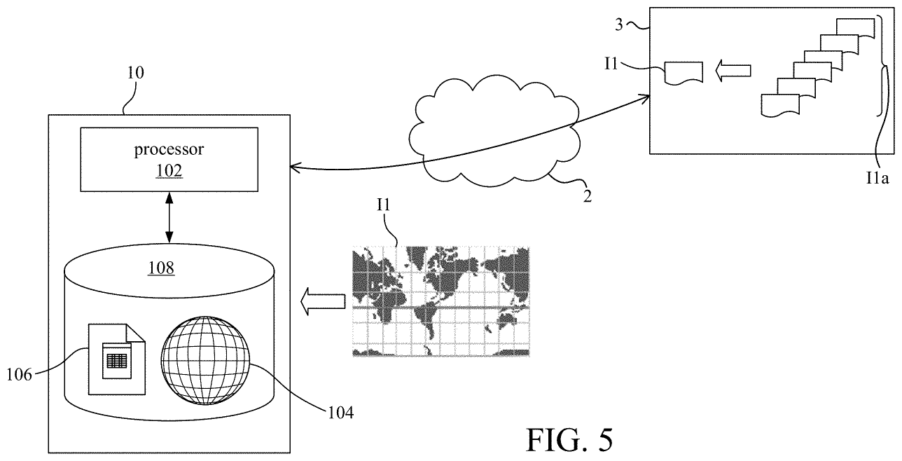

Referring to FIG. 5, FIG. 5 is a schematic diagram showing the architecture of the system 1, according to the preferred embodiment of the invention, for projecting the naked-eye three-dimensional image 13 from the selected two-dimensional image I1 and the linked cloud storage system 3.

As shown in FIG. 5, in one embodiment, the data processing apparatus 10 links to a cloud storage system 3 through a network 2. A plurality of candidate two-dimensional images I1a are stored in the cloud storage system 3. A user operates the data processing apparatus 10 to link to the cloud storage system 3 through the network 2, to select the selected two-dimensional image I1 from the plurality of candidate two-dimensional images I1a, and to import the selected two-dimensional image I1 into the data processing apparatus 10. The system 1 according to the invention can solve, by use of the cloud storage system 3, the problem of insufficient image sources and the problem that the naked-eye three-dimensional image 13 cannot be exhibited in real time.

In one embodiment, the network 2 can be an intranet, an internet, an extranet, a local area network, a wide area network, an Ethernet, a cable TV network, a radio telecommunication network, a public switched telephone network, a 3G network, a 4G network, a 5G network, a 6G network, an HSPA network, a Wi-Fi network, a WiMAX network, an LTE network, or other popular commercial public network.

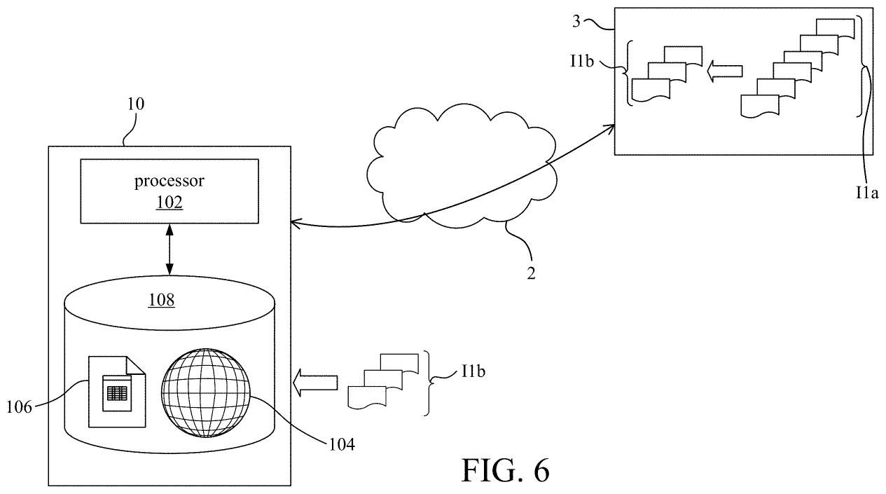

Referring to FIG. 6, FIG. 6 is another schematic diagram showing the architecture of the system 1 according to the preferred embodiment of the invention and the linked cloud storage system 3.

As shown in FIG. 6, in one embodiment, the data processing apparatus 10 links to a cloud storage system 3 through a network 2. A plurality of candidate two-dimensional images I1a are stored in the cloud storage system 3. A user operates the data processing apparatus 10 to link to the cloud storage system 3 through the network 2, to select a plurality of images I1b to be processed from the plurality of candidate two-dimensional images I1a, and to import the plurality of images I1b to be processed into the data processing apparatus 10. The at least one processor 102 of the data processing apparatus 10 executes the image processing application 106 to splice the plurality of images I1b to be processed into the selected two-dimensional image I1. The aforesaid procedure is not illustrated in FIG. 4. Thereby, the system 1 according to the invention can exhibit the naked-eye three-dimensional image 13 in real time.

With the detailed description of the above preferred embodiments of the invention, it is clear to understand that the system according to the invention can utilize simple information equipment and instruments to quickly project a selected two-dimensional image into a naked-eye three-dimensional image. The system according to the invention can solve the problems of complicated structure, high cost and insufficient source of images in the prior arts. The system according to the invention can also solve the problem that the prior arts cannot exhibit the three-dimensional image in real time and time continuity.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for projecting a naked-eye three-dimensional image from a selected two-dimensional image, comprising:
a data processing apparatus, comprising at least one processor, wherein the selected two-dimensional image is imported into the data processing apparatus, a predetermined three-dimensional virtual sphere is stored in the data processing apparatus, the at least one processor of the data processing apparatus executes an image processing application to project the selected two-dimensional image onto the predetermined three-dimensional virtual sphere according to a spherical plane coordinate conversion method to generate a three-dimensional spherical volume image, the spherical plane coordinate conversion method is one selected form the group consisting of a longitude and latitude mapping method, a spherical coordinate positioning method, a Mercator projection method, and a Gauss projection method;
a projection screen device, having a hemispherical projection surface; and
an image projection apparatus, capable of communicating with the data processing apparatus;
wherein the data processing apparatus projects the three-dimensional spherical volume image onto the hemispherical projection surface via the image projection apparatus such that the naked-eye three-dimensional image associated with the three-dimensional spherical volume image is exhibited on the hemispherical projection surface.

2. The system of claim 1, further comprising a distance sensing apparatus capable of communicating with the data processing apparatus, wherein the distance sensing apparatus is disposed to sense a distance between the image projection apparatus and the projection screen device, and to transmit the sensed distance to the data processing apparatus, the at least one processor executes the image processing application to adjust a size of the three-dimensional spherical volume image in accordance with the sensed distance such that the naked-eye three-dimensional image is completely fitted on the hemispherical projection surface.

3. The system of claim 2, wherein the distance sensing apparatus emits an optical wave or an acoustic wave to sense the distance between the image projection apparatus and the projection screen device.

4. The system of claim 2, wherein the distance sensing apparatus complies with a first wireless communication protocol to communicate with the data processing apparatus, the first wireless communication protocol is one selected from the group consisting of an Intel WiDi protocol, a WiFi Display protocol, a WHDI protocol, a WiDi protocol, a 5G WiFi protocol, a WiGig 802.11ad protocol, a WiHD 802.11ac protocol, IEEE 802.11 protocols, a 3G network protocol, a 4G network protocol, a 5G network protocol, a 6G network protocol, an HSPA network protocol, an LTE network protocol, and a bluetooth protocol.

5. The system of claim 1, further comprising an image capturing apparatus capable of the data processing apparatus, wherein the image capturing apparatus is disposed to capture a captured image associated with the naked-eye three-dimensional image, and to transmit the captured image to the data processing apparatus, the at least one processor executes the image processing application to adjust a size of the three-dimensional spherical volume image in accordance with the captured image such that the naked-eye three-dimensional image is completely fitted on the hemispherical projection surface.

6. The system of claim 5, wherein the image capturing apparatus complies with a second wireless communication protocol to communicate with the data processing apparatus, the second wireless communication protocol is one selected from the group consisting of an Intel WiDi protocol, a WiFi Display protocol, a WHDI protocol, a WiDi protocol, a 5G WiFi protocol, a WiGig 802.11ad protocol, a WiHD 802.11ac protocol, IEEE 802.11 protocols, a 3G network protocol, a 4G network protocol, a 5G network protocol, a 6G network protocol, an HSPA network protocol, an LTE network protocol, and a bluetooth protocol.

7. The system of claim 1, wherein the data processing apparatus links to a cloud storage system through a network, a plurality of candidate two-dimensional images are stored in the cloud storage system, a user operates the data processing apparatus to link to the cloud storage system through the network, to select the selected two-dimensional image from the plurality of candidate two-dimensional images, and to import the selected two-dimensional image into the data processing apparatus.

8. The system of claim 1, wherein the data processing apparatus links to a cloud storage system through a network, a plurality of candidate two-dimensional images are stored in the cloud storage system, a user operates the data processing apparatus to link to the cloud storage system through the network, to select a plurality of images to be processed from the plurality of candidate two-dimensional images, and to import the plurality of images to be processed into the data processing apparatus, the at least one processor executes the image processing application to splice the plurality of images to be processed into the selected two-dimensional image.

9. The system of claim 1, wherein the image projection apparatus complies with a third wireless communication protocol to communicate with the data processing apparatus, the third wireless communication protocol is one selected from the group consisting of an Intel WiDi protocol, a WiFi Display protocol, a WHDI protocol, a WiDi protocol, a 5G WiFi protocol, a WiGig 802.11ad protocol, a WiHD 802.11ac protocol, IEEE 802.11 protocols, a 3G network protocol, a 4G network protocol, a 5G network protocol, a 6G network protocol, an HSPA network protocol, an LTE network protocol, and a bluetooth protocol.
